(19) United States
(12) Patent Application Publication
(10) Pub. No.: US 2010/0106547 A1
(43) Pub. Date: Apr. 29, 2010

(54) Automated workflow generation

(76) Inventors: Asaf Adi, Qiryat Ata (IL); Maya Barnea, Kiriat Bialik (IL); Nili Guy, Kiriat Ata (IL); Samuel Kallner, D.N. Menashe (IL); Yoav Rubin, Haifa (IL); Gal Shachor, Yokneam (IL)

Correspondence Address: IBM CORPORATION, T.J. WATSON RESEARCH CENTER, P.O. BOX 218, YORKTOWN HEIGHTS, NY, 10598, US

(21) Appl. No.: 12/260,100

(22) Filed: Oct. 29, 2008

(51) Int. Cl. G06F 9/46

(52) U.S. Cl. 705/8

(57) ABSTRACT

A computer-implemented method for generating a workflow includes receiving via an interactive user interface operator input that defines a first document that is to be filled in by a user and comprises a decision component. A first state of the workflow corresponding to the first document and a transition associated with actuation of the decision component are automatically defined. A second document that is to be presented upon user selection of the decision component in the first document is generated, and a second state of the workflow that corresponds to the second document and is linked to the first state by the transition is generated. In response to the first and second documents and the decision component, software code that corresponds to the workflow is produced for use in a workflow engine.

### BACKGROUND

The present invention relates generally to the field of automated workflow, and specifically to systems and methods for automatically generating workflows using interactive user interface elements.

Automated workflow technologies may be used to represent a process in software as a workflow. Workflow designers typically break the process into discrete parts to be executed and supervised until some completion criteria are achieved. Constructing the workflow typically requires programming skills and extensive knowledge of the workflow system. One example of a workflow designer is the Microsoft Windows™ Workflow Foundation for the Visual Studio® development system, available at the Workflow Foundation website (msdn.microsoft.com). The Workflow Foundation provides a programming model, engine, and tools to support rapid development of workflows by using a graphical user interface.

### SUMMARY

An embodiment of the present invention provides a method for generating a workflow, which is carried out by receiving via an interactive user interface operator input that defines a first document that is to be filled in by a user and includes a decision component. A first state of the workflow corresponding to the first document is automatically defined and a transition is associated with actuation of the decision component. A second document that is to be presented upon user selection of the decision component in the first document is generated and a second state of the workflow that corresponds to the second document and is linked to the first state by the transition is generated, and in response to the first and second documents and the decision component, software code that corresponds to the workflow for use in a workflow engine is automatically produced. The software code includes markup-language code.

An embodiment of the method provides a workflow application running on the workflow engine, wherein the software code is introduced into the workflow application to delineate the workflow. The decision component is selected from a group of user interface components consisting of a button and a link. The first document includes fields that are to be filled in by the user, and generating the second document includes automatically generating a default version of the second document containing one or more of the fields from the first document. Generating the second document includes receiving further operator input defining one or more further elements for inclusion in the second document, wherein the one or more further elements includes a further decision component, and automatically defining a third state of the workflow that is linked to the second state by a further transition associated with actuation of the further decision component. Receiving the operator input includes receiving a definition of one or more decision components corresponding to multiple choices to be made by the user, wherein automatically defining the first state includes defining multiple transitions to different states corresponding respectively to the choices.

There is further provided, according to an embodiment of the present invention, an apparatus for workflow generation, including:

a display presenting an interactive user interface;

an input device; and

a processor, which is coupled to receive a receive via the interactive user interface operator input that defines a first document that is to be filled in by a user and includes a decision component, to automatically define a first state of a workflow corresponding to the first document and a transition associated with actuation of the decision component, to generate a second document that is to be presented upon user selection of the decision component in the first document and to automatically define a second state of the workflow that corresponds to the second document and is linked to the first state by the transition, and in response to the first and second documents and the decision component, to automatically produce software code that corresponds to the workflow, for use in a workflow engine.

An embodiment of the invention provides a product including a computer-readable medium in which computer program instructions are stored, which instructions, when executed by a computer, cause the computer to receive via an interactive user interface operator input that defines a first document that is to be filled in by a user and includes a decision component, to automatically define a first state of the workflow corresponding to the first document and a transition associated with actuation of the decision component, to generate a second document that is to be presented upon user selection of the decision component in the first document and to automatically define a second state of the workflow that corresponds to the second document and is linked to the first state by the transition, and in response to the first and second documents and the decision component, to automatically produce software code that corresponds to the workflow, for use in a workflow engine.

### BRIEF DESCRIPTION OF THE SEVERAL VIEWS OF THE DRAWINGS

For a better understanding of the present invention, reference is made to the detailed description of the invention, by way of example, which is to be read in conjunction with the following drawings, wherein like elements are given like reference numerals, and wherein:

FIG. 1 is a block diagram that schematically illustrates a system for automatic generation of a workflow, in accordance with an embodiment of the present invention;

FIGS. 2 and 3 are schematic illustrations of a user interface screen for editing graphical user interface elements, in accordance with an embodiment of the present invention;

FIG. 4 is a composite schematic showing a document and a workflow, in accordance with an embodiment of the present invention; and

FIG. 5 is a flow chart that schematically illustrates a method for automatic generation of a workflow, in accordance with an embodiment of the present invention.

### DETAILED DESCRIPTION

### Overview

Embodiments of the present invention that are described hereinbelow provide improved methods, products and systems for generation of workflows using an interactive user interface. There are many kinds of interactive user interfaces, such as graphical, voice response and eye tracking, and all such interactive user interfaces are considered to be within the scope of embodiments of the present invention. In a collaborative workflow, people cooperate with each other and with automated processes by interacting with the workflow using a user interface. In the context of the patent application and claims, the collaborative workflow is referred to simply as the “workflow.” In the past, some interactive user interfaces required a developer or an operator to design the workflow by abstraction of flows and relationships in one task, and to develop a representation of the interactive user interface for each state or phase of the workflow in a separate task.

In embodiments of the invention, the operator is provided with a graphical user interface (GUI) for creating a user interface document that has a decision component. In alternate embodiments, other interactive user interfaces may be provided, as described hereinabove. The decision component is a component in the user interface that visually represents a workflow decision. The decision component is typically displayed in the GUI as a button or a link, although other visual representations of the workflow decision known to those who are skilled in the art may be used. The operator creates the document and configures the decision component in a first document. The operator typically also populates the document with graphical user interface elements for data entry and data management, including fields such as text fields and check boxes. In the context of the present patent application and in the claims, the term “document” refers to a representation of a body of information designed with the capacity to communicate, such as a form, catalog or report.

A GUI generation software module automatically generates a second document, typically a default version of the second document containing one or more of the fields from the first document, in response to characteristics of the decision component. The operator may accept the second document that is generated by the GUI, or may alter the second document to input additional graphical user interface elements. The operator may also configure additional decision components. The GUI generation software module uses the first and second documents and the decision component to automatically produce code that corresponds to a workflow and describes the workflow. The GUI generation software module does not require the operator to abstract flows and relationships in order to produce the workflow. That is to say, embodiments of the invention enable the operator to automatically produce software code corresponding to the workflow for ultimate use in a workflow engine simply by manipulating graphical user interface elements, e.g., by creation of the documents and configuration of the decision component, without the operator needing to perform complex abstract modeling. In the disclosed embodiment, the GUI generation software module submits the software code to a transformation engine, the output of which is acceptable to the workflow engine.

In the context of the present patent application and in the claims, the term “workflow” refers to a state machine workflow, typically a model of behavior composed of a finite number of states, transitions among those states, and actions. A workflow engine may use the code corresponding to the workflow in order to operate a workflow application. The workflow application may present the documents to a user using the GUI. Typically, a user fills out the documents, which may comprise fields to be filled out. The user may select the decision component from a group of user interface components, which may consist of buttons and links. In alternative embodiments, the documents may be filled out by the user providing voice replies to an interactive voice response system or eye movements to an eye tracking system, or by using any method known in the art for users to fill out documents via interactive user interfaces.

One example of a workflow application that could be operated in the present context manages the flow of a purchase order that moves through various departments for authorization and eventual actualization as a purchase. Another example workflow application may be used in health care activities to manage the flow of a patient through a health care system from initial contact, e.g., beginning with a call to set up an examination, and continuing until receipt of payment from the patient (or his insurer) in response to receiving a billing invoice for the examination.

### System Description

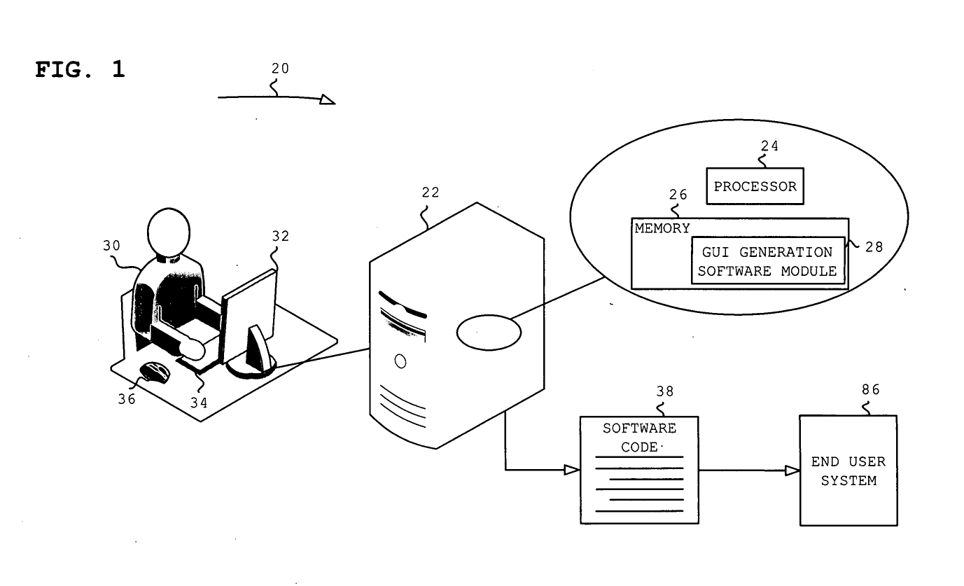

Reference is now made to FIG. 1, which is a block diagram that schematically illustrates a system 20 for automatic generation of a workflow, in accordance with an embodiment of the present invention. System 20 typically comprises a general-purpose computer 22, which is programmed in software to carry out the functions that are described herein. Computer 22 comprises a processor 24 and a memory 26, which holds data structures and information that are used in performing these functions. A GUI generation software module 28 is held in memory 26 and runs on processor 24. GUI generation software module 28 may be downloaded to computer 22 in electronic form, over a network, for example, or it may alternatively be provided on tangible media, such as optical, magnetic or electronic memory media. Further alternatively, at least some of the functions of computer 22 may be carried out by dedicated electronic logic circuits. Although this embodiment relates to one particular system for generating workflows, the principles of generating workflows that are implemented in system 20 may similarly be applied, mutatis mutandis, in other types of workflow generation systems, using other techniques for generating code that corresponds to workflows by manipulation of interactive user interface elements.

System 20 is controlled by an operator 30. Processor 24 operates a display 32. By way of example, operator 30 is assumed to operate computer 22 using a keyboard 34 and/or a pointing device 36, which provide operator inputs to computer 22. It will be understood, however, that operation of embodiments of the present invention is not limited to a particular method for inputting to computer 22, that any other suitable system for providing such operator inputs may be used, and that all such systems are considered to be within the scope of embodiments of the present invention.

GUI generation software module 28 uses inputs from operator 30 to generate software code 38 that corresponds to the workflow and describes the workflow. In some embodiments of the present invention, software code 38 may be provided to an end user system 86 for use in a workflow application. GUI generation software module 28 illustrates one type of interactive user interface generation software module, as explicated hereinabove. For example, in an alternative embodiment, a voice response user interface generation software module may provide a different interactive user interface to operator 30, wherein audible inputs are received from operator 30 by the software module.

### Example Workflow

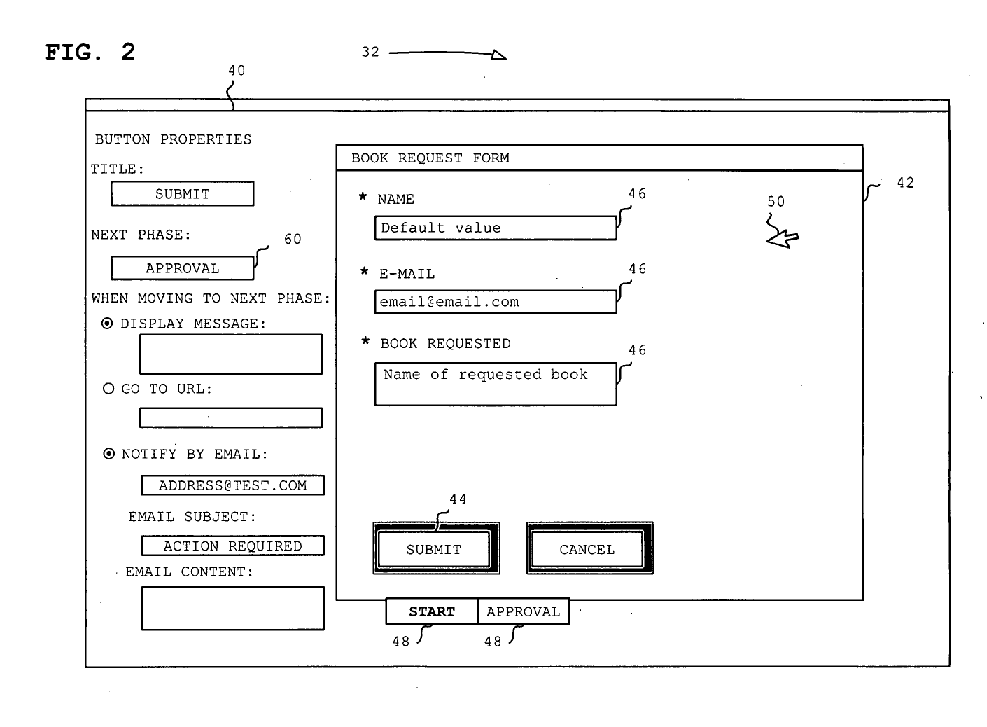

Reference is now made to FIG. 2, which is a schematic illustration of a user interface screen for editing graphical user interface elements, in accordance with an embodiment of the present invention. GUI generation software module 28 (FIG. 1) presents a GUI 40 for operator 30 to create a document 42 having a decision component 44 on display 32. For the purposes of illustration, document 42 is described using an example of a workflow for checking out a reference book from a library. The example workflow is typically found in a workplace or academic setting. An end user of end user system 86, e.g., an employee (not shown), may need to request a specific book from a reference library for the purposes of training and skill improvement. Operator 30 defines document 42, typically populating document 42 with graphical user interface elements 46 for data entry and data management by the end user. In the present example, graphical user interface elements 46 comprise the user name, user email address, and the name of the book being requested by the end user. The newly created document 42 is a first document, and corresponds to a first state of a workflow, herein referred to as a start state. In the present example, the end user is provided with GUI 40 for interaction with a workflow application as is described in more detail hereinbelow.

Operator 30 configures decision component 44, typically by using keyboard 34 (FIG. 1) to provide inputs to computer 22. Decision component 44, which is displayed by GUI generation software module 28 as a button in the present example, may also be displayed as a link or as any visual representation known in the art to indicate that an action occurs when the end user activates decision component 44. Typically, the end user activates decision component 44 by clicking on decision component 44 using a cursor 50 driven by pointing device 36. Activation of decision component 44 causes the document displayed by GUI 40 to transition from the start state to a second state, as described hereinbelow. Operator 30 may also use GUI generation software module 28 to configure additional activities for GUI 40 to actuate when the end user activates decision component 44. Additional activities may include displaying a message, issuing email notifications, and other workflow actions known to those who are skilled in the art.

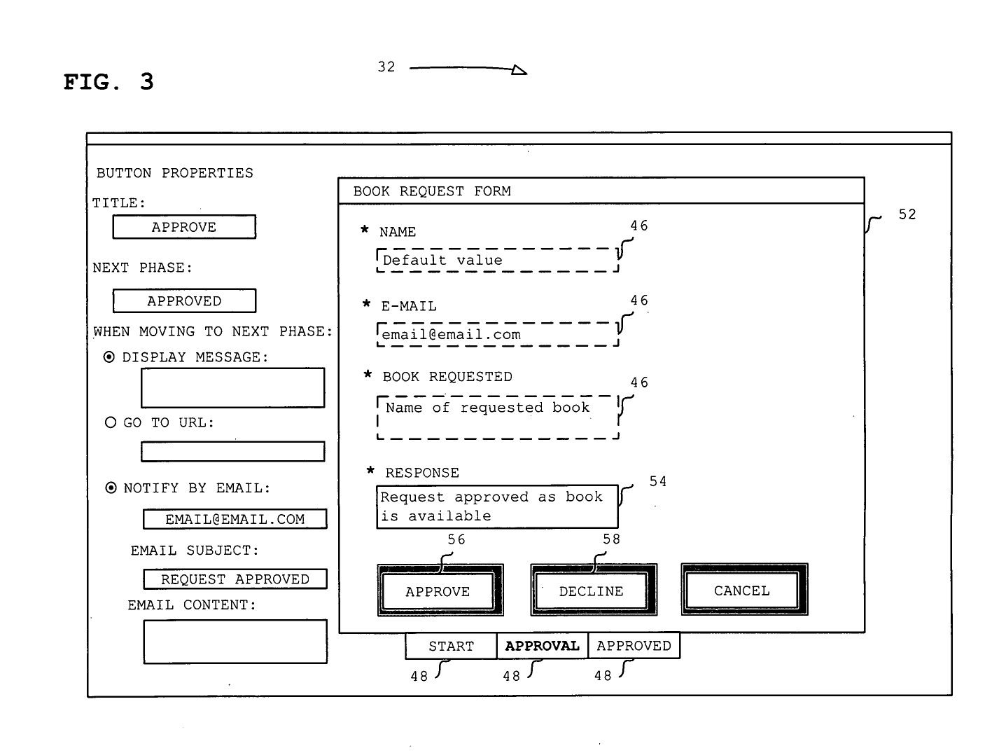

In the present example, operator 30 defines a label having the value “Submit” for decision component 44. The end user of GUI 40 may then click on decision component 44 in order to submit a request to check out the reference book. The GUI generation software module 28 automatically generates a second document 52 in response to configuration of decision component 44 by operator 30. Second document 52 corresponds to the second state of the workflow, and is shown in FIG. 3. Operator 30 defines a document label 60 for the second state, which has the value “Approval” in the present example.

Reference is now made to FIG. 3, which is a schematic illustration of a user interface screen for editing graphical user interface elements, in accordance with an embodiment of the present invention. GUI 40 (FIG. 2) displays second document 52 on display 32. Document label 60 is typically used to describe second document 52. GUI generation software module 28 may provide selection tabs 48 to enable operator 30 to switch among documents during configuration. Second document 52 is labeled in the current example as an approval state using bold characters on one of selection tabs 48. In the present example, second document 52 corresponds to the second state in the workflow, wherein GUI 40 presents a librarian with second document 52 and the librarian decides whether to approve or to decline the request from the end user.

When the end user activates decision component 44 as described hereinabove, the activation causes GUI 40 (FIG. 2) to transition from displaying document 42 to displaying second document 52. That is to say, the workflow transitions from the start state to the approval state, so that in the present example GUI 40 presents second document 52 to the librarian for approval of the book request.

The presence of broken lines around some graphical user interface elements 46 indicates that the elements are not editable. Operator 30 may accept the default second document 52 or may define an additional user interface element 54. In the present example, additional user interface element 54 comprises a field for the librarian to input a textual description of his response to the request.

Operator 30 may also define additional decision components 56, 58, and may assign labels to the components, such as “Approve” and “Decline” in the present example. As described hereinabove, GUI generation software module 28 generates additional documents automatically in response to the configuration of additional decision components 56, 58 by operator 30. In the current example, operator 30 defines the respective additional documents to have the labels “Approved” and “Declined” (not shown). In the present example, additional decision components 56, 58 correspond to states in the workflow in which the librarian has decided to approve or to decline the request. GUI generation software module 28 may also generate a further transition linking the second state to a third state, corresponding to one of additional decision components 56, 58. The further transition between the second state and the third state may be associated with actuation by the librarian of one of additional decision components 56, 58, e.g., by clicking on additional decision component 56. That is to say, the additional decision components defined by operator 30 correspond to multiple choices to be made by the librarian, the user in the present example. In the present example, GUI generation software module 28 automatically defines multiple transitions to different states that correspond to the choices that may be made by the librarian.

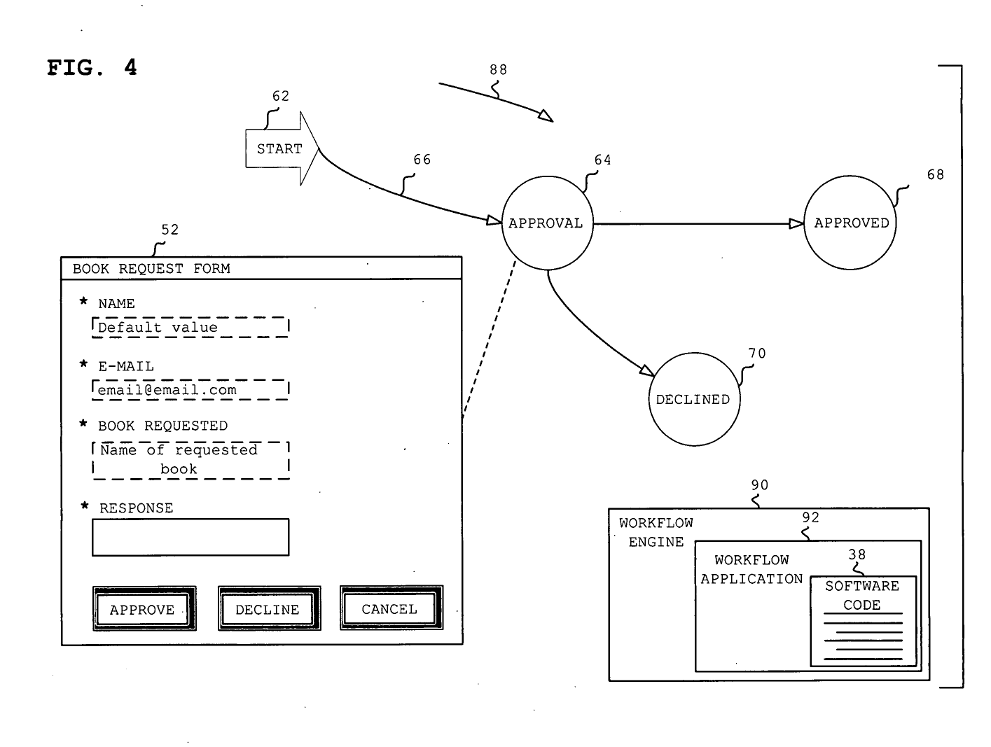

After operator 30 creates document 42, GUI generation software module 28 has generated second document 52, and operator 30 has configured decision component 44, processor 24 may generate software code that corresponds to a workflow for ultimate use in a workflow engine. Operator 30 may command GUI generation software module 28 to automatically produce the software code, typically by clicking on a button or link (not shown) provided by GUI 40. GUI generation software module 28 produces software code representing the workflow. An extensible markup language (XML) listing of sample software code representing a workflow that may be produced in this context is presented below in Listing 1. The use of XML in the sample software code is shown by way of example. The software code may alternatively be generated in many computer languages. A workflow application running on a workflow engine may use the software code as explained hereinbelow in reference to FIG. 4. The software code delineates the workflow by describing the states and transitions of the workflow, and the workflow engine may supply the ability for the workflow application to be provided to end users.

Reference is now made to FIG. 4, which is a composite diagram showing second document 52 and a corresponding workflow 88, in accordance with an embodiment of the present invention. Workflow 88 is represented in the figure as a state machine and forms the basis for generating software code 38 corresponding to the workflow for ultimate use in workflow engine 90. FIG. 4 is presented to facilitate understanding of an embodiment of the invention, using the workflow example described hereinabove. The sample code provided in Listing 1 contains tags that represent the workflow produced by GUI generation software module 28, corresponding to actuation of the decision components in different documents. Document 42 is shown as a first state node 62, and is represented in the sample code with the tag “phase name=“Start”.” In the present example, document 42 may be presented to the end user, who is thus able to submit the request to check out the reference book using document 42.

A first transition 66 is shown, representing the transition from first state node 62 to a second state node 64. GUI generation software module 28 generates first transition 66 by using the configuration of decision component 44 and is represented in the sample code with the tag “nextPhase=“Approval”.” Second document 52 is shown as second state node 64 labeled with the value of document label 60, and is represented in the sample code with the tag “phase name=“Approval”.” Although the example shown here relates, for clarity of illustration, to a very simple workflow, the techniques described herein may also be used, mutatis mutandis, to generate more elaborate workflows.

In an embodiment of the present invention, software code 38 is used by a known workflow engine 90, e.g., the OpenWFE open source Java™ workflow engine, to delineate a workflow application 92 and to provide the end user with GUI 40 (FIG. 2) for interaction with workflow application 92. The OpenWFE open source Java workflow engine is available at the Java-Source website (Java-source.net). Workflow application 92 displays second document 52 (FIG. 3) corresponding to the second state of workflow 88. Similarly, the workflow application displays corresponding documents (not shown) for matching states.

In the present example, other states represent outcomes of decisions by the librarian to approve or deny the request to check out the reference book. Additional decision components 56, (FIG. 3) correspond to additional nodes 68, 70 and represent additional states in the workflow.

### Workflow Generation

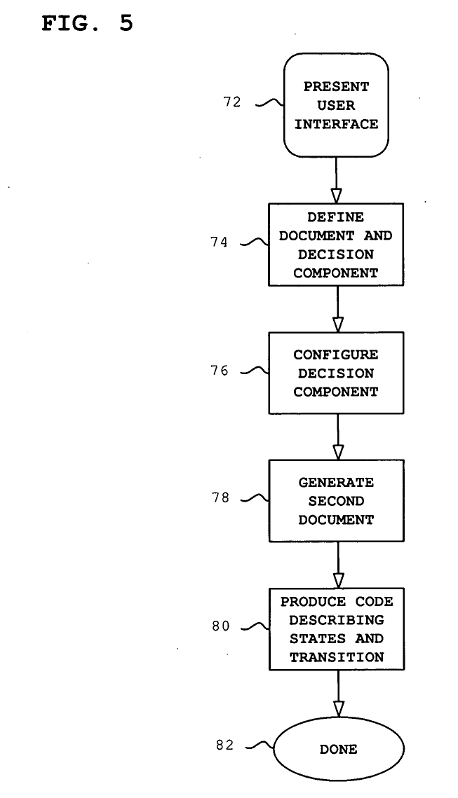

Reference is now made to FIG. 5, which is a flow chart that schematically illustrates a method for automatic generation of a workflow, in accordance with an embodiment of the present invention. GUI generation software module 28 (FIG. 1) causes processor 24 to present GUI 40 (FIG. 2) on display 32 to operator 30 and to perform the steps listed hereinbelow. GUI generation software module 28 provides operator 30 with GUI 40 for creation of document 42, in a user interface presenting step 72. In some embodiments, other interactive user interfaces may be provided, as described hereinabove.

Operator 30 (FIG. 1) creates document 42 (FIG. 2) with decision component 44 in a document and decision component defining step 74. Operator 30 creates document 42 and defines graphical user interface elements 46 for data entry and data management on document 42, in addition to defining decision component 44.

Decision component 44 (FIG. 2) is configured by operator 30 in a decision component configuration step 76. Operator 30 typically labels decision component 44 and configures activities for GUI 40 to actuate when the end user activates decision component 44.

GUI generation software module 28 (FIG. 1) generates second document 52 (FIG. 3) after decision component 44 is configured by operator 30 in a document generation step 78. Operator 30 may accept the default second document 52 or may make changes to second document 52, including insertion of additional user interface element 54 and additional decision components 56, 58. Operator 30 (FIG. 1) continues to make changes until he is satisfied with all of the graphical user interface elements in GUI 40 (FIG. 2). Operator 30 may then command GUI generation software module 28 to generate software code that corresponds to the workflow. GUI generation software module 28 automatically produces software code that describes the states and transitions among the states in a software code producing step 80.

The method then terminates at a final step 82.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code stored in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described herein with reference to flow chart illustrations and/or block diagrams of methods, apparatus (systems) and computer program products according to embodiments of the invention. It will be understood that each block of the flow chart illustrations and/or block diagrams, and combinations of blocks in the flow chart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flow charts and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flow charts and/or block diagram block or blocks.

The flow charts and block diagrams in the Figures illustrate the architecture, functionality, and operation of possible implementations of systems, methods and computer program products according to various embodiments of the present invention. In this regard, each block in the flow charts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flow chart illustrations, and combinations of blocks in the block diagrams and/or flow chart illustrations, can be implemented by special purpose hardware-based systems that perform the specified functions or acts, or combinations of special purpose hardware and computer instructions.

It will be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

COMPUTER PROGRAM LISTINGS
Listing 1

```
<workflow isUsing=”true”>
    <phase name=”Start”>
      <action title=”Submit” description=””
nextPhase=”Approval”>
        <uponLeaving
presentationType=”message”><![CDATA[ ]]></uponLeaving>
      </action>
      <cancel title=”Cancel” description=”When the user presses
this button the application window will be
closed”><![CDATA[ ]]></cancel>
      <entity name=”_Aform”>
        <entityAttribute name=”_ApproverComments”>
          <property
name=”ShownProperty”><![CDATA[false]]></property>
          <property
name=”EditableProperty”><![CDATA[false]]></property>
        </entityAttribute>
      </entity>
    </phase>
    <phase name=”Approval”>
      <action title=”Approve” description=””
nextPhase=”Approved”>
        <uponLeaving
presentationType=”message”><![CDATA[ ]]></uponLeaving>
        <notification type=”email” targetType=”fixed”
target=”ifergan@il.ibm.com” title=”Action
Required”><![CDATA[ ]]></notification>
      </action>
      <action title=”Reject” description=””
nextPhase=”Rejected”>
        <uponLeaving
presentationType=”message”><![CDATA[ ]]></uponLeaving>
      </action>
      <cancel title=”Cancel” description=”When the user presses
this button the application window will be
closed”><![CDATA[ ]]></cancel>
      <entity name=”_Aform”>
        <entityAttribute name=”_Name”>
          <property
name=”EditableProperty”><![CDATA[false]]></property>
        </entityAttribute>
        <entityAttribute name=”_BookName”>
          <property
name=”EditableProperty”><![CDATA[false]]></property>
        </entityAttribute>
      </entity>
    </phase>
    <phase name=”Approved”>
      <cancel title=”Cancel” description=”When the user presses
this button the application window will be
closed”><![CDATA[ ]]></cancel>
      <entity name=”_Aform”>
        <entityAttribute name=”_Name”>
          <property
name=”EditableProperty”><![CDATA[false]]></property>
        </entityAttribute>
        <entityAttribute name=”_BookName”>
          <property
name=”EditableProperty”><![CDATA[false]]></property>
        </entityAttribute>
        <entityAttribute name=”_ApproverComments”>
          <property
name=”EditableProperty”><![CDATA[false]]></property>
        </entityAttribute>
      </entity>
    </phase>
    <phase name=”Rejected”>
      <cancel title=”Cancel” description=”When the user presses
this button the application window will be
closed”><![CDATA[ ]]></cancel>
      <entity name=”_Aform”>
        <entityAttribute name=”_Name”>
          <property
name=”EditableProperty”><![CDATA[false]]></property>
        </entityAttribute>
        <entityAttribute name=”_BookName”>
          <property
name=”EditableProperty”><![CDATA[false]]></property>
        </entityAttribute>
        <entityAttribute name=”_ApproverComments”>
          <property
name=”EditableProperty”><![CDATA[false]]></property>
        </entityAttribute>
      </entity>
    </phase>
  </workflow>
```

1. A computer-implemented method for generating a workflow, comprising:
receiving via an interactive user interface operator input that defines a first document that is to be filled in by a user and comprises a decision component;
automatically defining a first state of the workflow corresponding to the first document and a transition associated with actuation of the decision component;
generating a second document that is to be presented upon user selection of the decision component in the first document and automatically defining a second state of the workflow that corresponds to the second document and is linked to the first state by the transition; and
responsively to the first and second documents and the decision component, automatically producing software code that corresponds to the workflow, for use in a workflow engine.

2. The method according to claim 1, wherein the software code comprises markup-language code.

3. The method according to claim 1, and comprising providing a workflow application running on the workflow engine, wherein the software code is introduced into the workflow application to delineate the workflow.

4. The method according to claim 1, wherein the decision component is selected from a group of user interface components consisting of a button and a link.

5. The method according to claim 1, wherein the first document comprises fields that are to be filled in by the user, and wherein generating the second document comprises automatically generating a default version of the second document containing one or more of the fields from the first document.

6. The method according to claim 5, wherein generating the second document comprises receiving further operator input defining one or more further elements for inclusion in the second document.

7. The method according to claim 6, wherein the one or more further elements comprise a further decision component, and wherein the method comprises automatically defining a third state of the workflow that is linked to the second state by a further transition associated with actuation of the further decision component.

8. The method according to claim 1, wherein receiving the operator input comprises receiving a definition of one or more decision components corresponding to multiple choices to be made by the user, and wherein automatically defining the first state comprises defining multiple transitions to different states corresponding respectively to the choices.

9. Apparatus for workflow generation, comprising:
a display presenting an interactive user interface;
an input device; and
a processor, which is coupled to receive via the interactive user interface operator input that defines a first document that is to be filled in by a user and comprises a decision component, to automatically define a first state of a workflow corresponding to the first document and a transition associated with actuation of the decision component, to generate a second document that is to be presented upon user selection of the decision component in the first document and to automatically define a second state of the workflow that corresponds to the second document and is linked to the first state by the transition, and responsively to the first and second documents and the decision component, to automatically produce software code that corresponds to the workflow, for use in a workflow engine.

10. The apparatus according to claim 9, wherein the software code comprises markup-language code.

11. The apparatus according to claim 9, wherein the processor is configured to provide a workflow application running on the workflow engine, wherein the software code is introduced into the workflow application to delineate the workflow.

12. The apparatus according to claim 9, wherein the decision component is selected from a group of user interface components consisting of a button and a link.

13. The apparatus according to claim 9, wherein the first document comprises fields that are to be filled in by the user, and wherein the processor is configured to automatically generate a default version of the second document containing one or more of the fields from the first document.

14. The apparatus according to claim 13, wherein the processor is configured to generate the second document by receiving further operator input to define one or more further elements for inclusion in the second document.

15. The apparatus according to claim 14, wherein the one or more further elements comprise a further decision component, and wherein the processor is configured to automatically define a third state of the workflow that is linked to the second state by a further transition associated with actuation of the further decision component.

16. The apparatus according to claim 9, wherein the processor is configured to receive a definition of one or more decision components corresponding to multiple choices to be made by the user, and wherein the processor is configured to automatically define the first state by defining multiple transitions to different states corresponding respectively to the choices.

17. A computer software product, comprising a computer-readable medium in which computer program instructions are stored, which instructions, when executed by a computer, cause the computer to receive via an interactive user interface operator input that defines a first document that is to be filled in by a user and comprises a decision component, to automatically define a first state of the workflow corresponding to the first document and a transition associated with actuation of the decision component, to generate a second document that is to be presented upon user selection of the decision component in the first document and to automatically define a second state of the workflow that corresponds to the second document and is linked to the first state by the transition, and responsively to the first and second documents and the decision component, to automatically produce software code that corresponds to the workflow, for use in a workflow engine.

18. The product according to claim 17, wherein the software code comprises markup-language code.

19. The product according to claim 17, and comprising providing a workflow application running on the workflow engine, wherein the instructions cause the computer to introduce the software code into the workflow application to delineate the workflow.

20. The product according to claim 17, wherein the decision component is selected from a group of user interface components consisting of a button and a link.

21. The product according to claim 17, wherein the first document comprises fields that are to be filled in by the user, and wherein the instructions cause the computer to automatically generate a default version of the second document containing one or more of the fields from the first document.

22. The apparatus according to claim 21, wherein the instructions cause the computer to generate the second document by receiving further operator input to define one or more further elements for inclusion in the second document.

23. The apparatus according to claim 22, wherein the one or more further elements comprise a further decision component, and wherein the instructions cause the computer to automatically define a third state of the workflow that is linked to the second state by a further transition associated with actuation of the further decision component.

24. The apparatus according to claim 17, wherein the instructions cause the computer to receive a definition of one or more decision components corresponding to multiple choices to be made by the user, and wherein the instructions cause the computer to automatically define the first state by defining multiple transitions to different states corresponding respectively to the choices.
